(19) United States
(12) Patent Application Publication
(10) Pub. No.: US 2009/0241317 A1
(43) Pub. Date: Oct. 1, 2009

(54) Method for Producing a Glass Pane

(76) Inventors: Rainer Kübler, Freiburg (DE); Günter Kleer, Buchenbach (DE); Rainer Kolloff, Breisach (DE); Martin Krappitz, Ettenheim (DE); Thorsten Faber, Freiburg (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/295,345

(22) PCT Filed: Jun. 4, 2007
(86) PCT No.: PCT/EP07/04955

§ 371 Date: May 29, 2009

(30) Foreign Application Priority Data
Jun. 2, 2006 (DE) 10 2006 025 912.2

(51) Int. Cl. B23P 11/00

(52) U.S. Cl. 29/428

(57) ABSTRACT

A method is described for producing a glass pane having at least one edge section delimiting the glass pane, for whose production the glass pane has been severed along the edge section with the aid of a severing procedure comprising a thermal energy introduction.

The invention of the glass pane is enclosed at least sectionally and preferably along the entire edge section by a sheath immediately after production of the at least one edge section using a severing procedure comprising a thermal energy introduction.

### BACKGROUND OF THE INVENTION

1. Field of the Invention

The invention relates to a method for producing a glass pane having at least one edge section, in which during production of the glass pane the edge section has been severed by a severing procedure comprising introduction of a thermal energy and to a glass pane which has been produced using the method.

2. Description of the Prior Art

In addition to the severing of flat glasses via mechanical scoring using a scoring wheel and subsequent bending fracture and the resulting known poor edge qualities thus arising, caused by local boundary chipping and low strength of the glass, methods exist in selected marked areas application, in which the glass pane is either severed by a crack cutting through the glass pane which is driven by thermal tensions or a crack running in the glass surface which is also driven by thermal tensions and the subsequent bending fracture. The combination of both methods is conceivable. A very cursory list of publications disclosed these methods: DE 199 63 939 A1, EP 1 336 591 A3, EP 0633 867 B1, EP 0448 168 A1, U.S. Pat. No. 6,252,197 B1, U.S. Pat. No. 6,407,360 B1, U.S. Pat. No. 5,984,159, U.S. Pat. No. 6,112,967, US 2002/0125232 A1, and US 2003/0209528 A1.

In all of these cases, referred hereafter as “thermally cut edges”, a significantly higher quality glass edge is obtained than with conventional scoring and breaking. Thus, a glass pane processed using normal edge cutting has a significantly higher strength and outstanding visual edge quality, for example, and may additionally be produced without any splinter formation and shells at the edge boundary, in contrast to conventional scoring and breaking. The strength of the thermally cut edges is so great that processing steps such as edging, beveling, grinding, or polishing contribute more to decreasing the edge strength and worsening the edge quality, particularly because flaws may be introduced into the edge in this way.

Glass panes having thermally cut edges have, for example, in the four-point bending test, approximately 2.5 times more strength than glass panes cut to size by mechanical scoring and breaking. More precise studies of fracture patterns of overstressed glass panes have shown that with a typical type of strain, in which both the glass pane surface and also the glass pane edge are each loaded in a comparable way simultaneously, the fracture origins in case of panes having thermally severed edges are not at the glass edge. The glass surface, in contrast, for mechanically scored and broken edges, even after complex postprocessing steps are applied, has the fracture origins beginning on the glass edge. These findings illustrate the importance of the extremely slight susceptibility to fracture at the edge in the event of the occurrence of bending or tensile strains in comparison to the glass pane surface. In addition, the amount of strength increase obtained using the thermally induced edge production does not even represent the limit of the maximum achievable edge strength, but rather is limited by the flaws introduced into the glass surfaces during the production and further processing process of float glass.

According to the currently prevailing opinion and existing specifications, the edges of glass panes are beveled, ground, or even complexly polished for specific production processes and applications having slightly increased strength requirements, such as pre-tensioned panes in such as single-pane safety glass or partially pre-tensioned glass or composite safety glass panes. With even higher requirements for strength, for example, in the field of architecture, in addition to the edge processing, the glass thickness must be increased and/or the possible design must be adapted to that feasible on the basis of the achievable strength. However, it is known that glass is capable of having a significantly higher strength, but this is not achievable as a result of the inadequate edge quality after mechanical scoring and breaking and with subsequent processing of the glass edge. Until now, many applications of glass as a supporting material have therefore not been possible using the glass panes available until now.

Because of a sharp transition of the thermally cut edge to the glass surface which forms, however, the edge is disadvantageously especially impact-sensitive, however, so that even slight mechanical strains, for example, caused by being set down, hitting against another glass edge, etc., as commonly occur during correct handling, during transport, further processing, and the installation and use of glass panes, for example, may automatically result in edge damage, from microscopically small to chips and damage visible with the naked eye. Smaller flaws in the edges decrease the edge strength and in the event of larger damage, the edge strength suffers in an amount up to the level of a mechanically scored and broken glass pane.

High edge strength and the advantages connected thereto, such as lesser material requirement, equal strength or greater strength reserves which occurs with identically dimensioned panes, in comparison to the properties resulted from mechanical scoring and breaking, may be lost irretrievably with edge damage. The existing danger of damage explained above prevents a broad application of high strength thermally cut glass.

If the outstanding property of the high strength of glass panes having thermally cut edges is to be maintained, the edge must be provided undamaged over the entire period of processing and usage after cutting to size.

### SUMMARY OF THE INVENTION

The invention has the objective of reducing the danger of damage to thermally cut glass at the glass edges, so that thermally cut glass may be supplied for wider application and confident use.

A method according to the invention for producing a glass pane having at least one edge section, with the glass pane having been severed along the edge section with a severing procedure utilizing thermal energy, includes the glass pane being enclosed by a sheath at least sectionally, preferably along the entire edge section, immediately after production of the at least one edge section by using thermal energy introduction.

The method according to the invention is based upon, immediately after the production of the glass pane edge, protecting the edge appropriately from external mechanical effects, even before the glass pane has been subjected to further handling steps which strain the glass pane edge, such as being set down, temporary storage, grasping and transportation, etc. The glass pane is thus, according to the solution, sheathed immediately after the severing procedure using thermal energy introduction, that is, without physical contact with the resultant edge section and/or without mechanical tension and/or force action on the produced edge section. The sheath is produced, for example, from a plastic or material having plastic in the course of an immersion, injection, spraying, foaming, push-on, or plug-on procedure and applied around the edge area.

The edge protector may only be removed when the glass pane is being used as intended and it has been transported and positioned carefully to a corresponding usage location, if the usage conditions require it, otherwise the edge protector remains permanently on the edge area to be protected.

The sheath, which is applied along the at least one thermally cut edge section of the glass pane after appropriate selection in regard to material, shape, and size, is used as an edge protector in such a way that a reduction of the strength of the glass edge is completely avoided or, in any case, a decrease of the strength is maintained by a still permissible defined amount. The edge protector and/or the sheath is provided permanently around the at least one edge area in such a way that the sheath fulfills its protective function in each case tailored to various steps regarding proper handling, transport, appropriate further processing as well as possible installation and/or integration of the glass pane in a system receiving the glass pane, such as a window frame.

The sheath preferably comprises a permanently[-] elastic plastic material, which is preferably applied flush along the edge section. The sheath covers both the front face of the edge section and also boundary areas of the glass pane faces directly adjoining the front face. It is thus ensured that the damage-sensitive edge lines are completely enclosed by the sheath. Plastics which adhere to glass are suitable with especially preferable sheath material, such as elastomers, preferably organic elastomers, for example, polyurethane, acrylic lacquer, acrylates in connection with polyurethane, polyisocyanate, silicone, epoxide resin, PVC, etc. To increase the adhesive strength on glass of plastic-based sheath material, an appropriate primer additive may additionally be used.

It is also possible to embed the edge area to be protected in foam properly using foam-like, elastic, porous plastic materials. For example, polyurethane foam, foamed polyethylenes, polypropylenes, polyisocyanates, to name only a few, are suitable for this purpose. Filled plastics, preferably having various plastic material components and elasticities, are also conceivable.

If most plastics applied directly to the edge area of a glass pane to be protected are capable of producing a purely adhesive bond with the glass surface, it is also conceivable to provide a sheath for an edge protector on the glass pane which is predominantly fastened by clamping and/or by friction thus generated on the contact areas to the glass pane. In the case of an edge plug-on rail manufactured from foam material, for example, usually merely plugging or pushing the rail onto the edge to be protected is sufficient to ensure adequate adhesion and/or fastening of the rail on the edge area. If materials harder than foams are used, the contact surfaces between the suitable selected edge protector and edge area of the glass pane are to be defined and a sufficient contact pressure between the sheath and the glass pane is to be ensured using suitable measures, for example, using clamping aids or by materials having internal pre-tension within the sheath. It is thus also possible to manufacture the sheath from wood, Ormocers, or similar hybrid materials, i.e., inorganic/organic hybrid materials. Also and in particular, combinations of elastic materials on the inside, i.e., the side facing toward the glass pane, and solid material, such as metal, plastics, or fiber-reinforced materials, on the outside of the sheath forming the edge protector are conceivable.

Fundamentally, plastic materials of this type may be applied along the at least one edge area to be protected in the course of an immersion procedure, by spraying, embedding in foam, extrusion coating, or sheathing. In addition to the use of materials capable of casting, flowing, or spraying, however, permanently adhesive inorganic materials are also usable for implementing the protective sheath, which are applicable along the edge area to be protected in the course of a push-on or plug-on procedure. Suitable materials for this purpose are metals, preferably metals plastically deformable under strain, such as aluminum, tin, or metal alloys.

Alternatively to the use of sheath materials adhering directly to the glass and front face top sides, sheaths are also usable which do enclose the front face of the edge area, but do not contact it directly, but rather stretch over and/or around it in an arc. In this case, the sheath adheres and/or presses against the boundary areas of the two glass pane faces adjoining the front face in the edge area. By the contactless configuration of the sheath in relation to the front face, it may be ensured that the properties of the front face determining the strength of the edge area and those of the edge curves remain completely uninfluenced, but nonetheless care is taken here to effectively protect particularly these areas from external mechanical effects. Because of the intrinsic elasticity of the particular selected sheath material and by providing a cavity enclosed with the edge area, with a design of the sheath of this type, a type of crumple zone is provided, by which the edge area is protected from external mechanical influences.

Further details describing the sheath may be inferred hereafter from the description with reference to the exemplary embodiments.

It is obvious that the size and geometry selection of the sheath protecting the particular edge area is a function of the particular thickness and size of the glass pane itself. Thus, in a simplest construction having small dimensions, the sheath may be implemented in the form of a thin lacquer layer, which locally encloses the edge area. However, if thicker and larger-area glass panes are used, sheaths having a thickness of a few millimeters up to a few centimeters or decimeters may be selected. If the mechanical protection of sheaths usually manufactured from plastic materials is to be improved further, the combination with separately selected reinforcement materials is suitable, which may themselves comprise thermoplastics or metals, for example, such as aluminum or steel, and which may be embedded in the sheath or applied to the particular surface of the sheath. A preferred embodiment, for example, provides an external additional metal sheath, which encloses the sheath typically manufactured from elastic plastic material.

In addition to solely protecting the edge area from external mechanical influences, the sheath is capable of unifying additional functional properties, depending on the design and dimensioning, such as a sealing function or a fitting function for installation in frame systems enclosing the glass pane. As already noted at the beginning, the measure according to the solution is to simplify the handling and integration of thermally cut glass panes in buildings or facility areas, for example, without an excess of care having to be taken in regard to the breaking danger of an exposed thermally cut glass pane edge.

Depending on the intended application and use, it is possible to select the material of the sheath from transparent, colored, or light-absorbing plastic material, whose surface may be implemented as matte, glossy, or textured as needed.

The entire length of the edge area is not necessarily enclosed by the sheath according to the solution, which is often advantageous in regard to a desirable complete edge protector, however, but the edge protector in the form of the sheath implemented according to the solution may nonetheless only be provided on selected areas along the edge area, which are subjected to a strain to be expected, if it is ensured by further technical measures that the remaining edge areas remain unharmed.

The measure according to the invention for protecting thermally cut glass edges may fundamentally be applied to any type of glass panes, thus, for example, to composite safety glass panes, insulating glass, or single-layer glass plates independently of whether they have been annealed or subjected to further tempering.

### BRIEF DESCRIPTION OF THE DRAWINGS

The invention is explained for exemplary purposes hereafter without restriction of the general idea of the invention on the basis of exemplary embodiments with reference to the drawings. In the figures:

FIGS. 1 through 8 show diverse embodiment variants of the sheath which encloses a thermally cut edge area of a glass pane; and

FIGS. 9a, b and c show processing steps for producing the edge protector according to the solution.

### DETAILED DESCRIPTION OF THE INVENTION

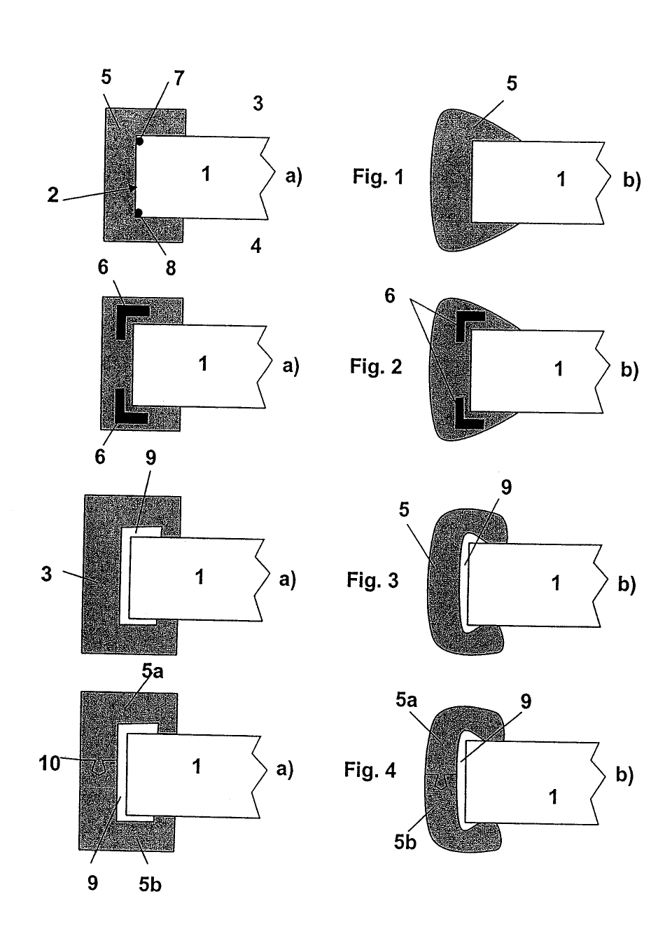

FIGS. 1a and b each show a typical cross-section through a glass pane 1 in the boundary area, in which it is to be assumed that the edge section has been produced with the aid of a thermal energy introduction. The edge section itself has a front face 2, which typically intersects the opposing glass pane faces 3 and 4 perpendicularly. This assumption applies for all exemplary embodiments shown and may be assumed to be largely realistic, although production-related deviations from an exactly orthogonal orientation of the front face 2 in relation to the adjoining glass pane faces 3 and 4 may occur.

A sheath 5 enclosing the front face and the boundary areas of the glass pane 3, 4 is shown in FIG. 1a, which adheres directly on the particular glass surface of the edge area. It is to be assumed that the sheath 5 comprises a self-curing plastic material which may be cast, poured, sprayed on, or molded in another suitable way. The embodiment according to FIG. 1a is a perfectly-geometric U-profile in cross-sectional shape, but it is also possible to design the sheath 5 having an external freeform face according to the cross-sectional illustration in FIG. 1b. The shaping of the sheath 5 is finally a function of the particular production process, which may be implemented in the form of an immersion, injection, spraying, foaming, push-on, or plug-on procedure. To ensure the most effective possible edge protector, in particular for the highly-endangered edges 7 and 8, the most elastic possible materials are to be provided for the sheath 5, which are to be as shock absorbing as possible. The edge area to be protected typically extends to the particular corners at which the glass pane areas 3, 4 and the front face 2 run together. The shaping of the sheath may also be significant for a later use, for example, as a frame or frame element for integration in windows, etc.

For further mechanical reinforcement of the sheath 5, the exemplary embodiment in FIGS. 2a and b provides reinforcement elements or materials 6 integrated inside the sheath 5, which are completely integrated or embedded in the matrix of the sheath 5 in such a way that they are used to protect the edge area 7 and 8. Preferred materials for reinforcement elements 6 of this type are, for example, thermoplastics or metals in the form of aluminum or steel rails which are situated longitudinally to the particular edge areas 7 and 8.

A further embodiment is shown in FIGS. 3a and b, in which the sheath 5 is exclusively joined to the boundary areas of the glass pane faces 3 and 4 and is spaced apart in the remaining area in relation to the glass pane, in particular the edge areas 7 and 8. The sheath 5 thus encloses an internal volume 9, which may additionally assume the function of a type of crumple zone. In this way, the implementation of the sheath additionally ensures that the production-related surface nature of the edge area 7 and 8 is not changed in any way, by which the strength properties of the edge area, in particular the front face, finally also remain unimpaired. Implementing the sheath shown in FIGS. 3a and b as a plug-on or push-on rail is conceivable, which may be pushed on laterally along the edge course after manufacturing of the glass pane.

A further alternative mounting form of a sheath of this type which protects the edge area of a glass pane is shown in FIGS. 4a and b, which show a sheath 5 which comprises two segments 5a and 5b, which provide a joint 10 along the edge course, via which the two sheath segments 5a and 5b may be permanently joined to one another. For example, a type of snap closure mechanism suggests itself as a typical joining and thus mounting mechanism, as may be inferred from FIGS. 4a and b. In this way, the sheath may be taken off of the glass pane again and reused on another glass pane.

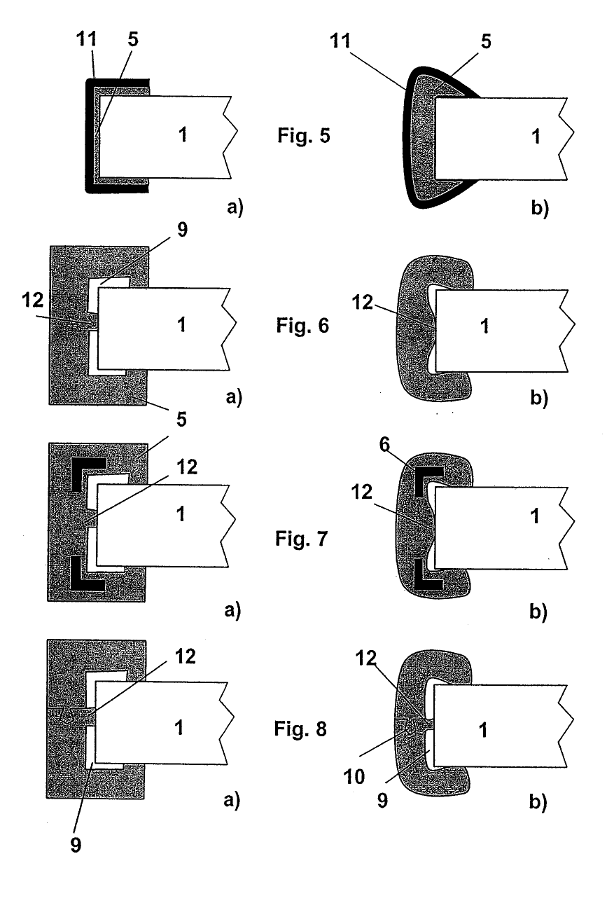

An embodiment which mechanically stabilizes the sheath may be inferred in each case from FIGS. 5a and b, in which in addition to the sheath 5 manufactured from preferably elastic plastic material, an external mechanical protection and possibly support structure 11 is provided, for example, in the form of an additional metal layer. The metal layer 11, which may possibly also be manufactured from another stable metal, may also have other functional properties in addition to its mechanically improving protection and support function, such as seal functions or increasing or improving thermal or chemical resistance from external effects.

Further embodiments for sheaths 5 are shown in FIGS. 6 through 8, which, in addition to the properties already described above, provide additional support structures 12, which support the sheath 5, which is implemented in each case as spaced apart from the front face 2 and encloses a cavity 9 therewith, locally on the front face 2.

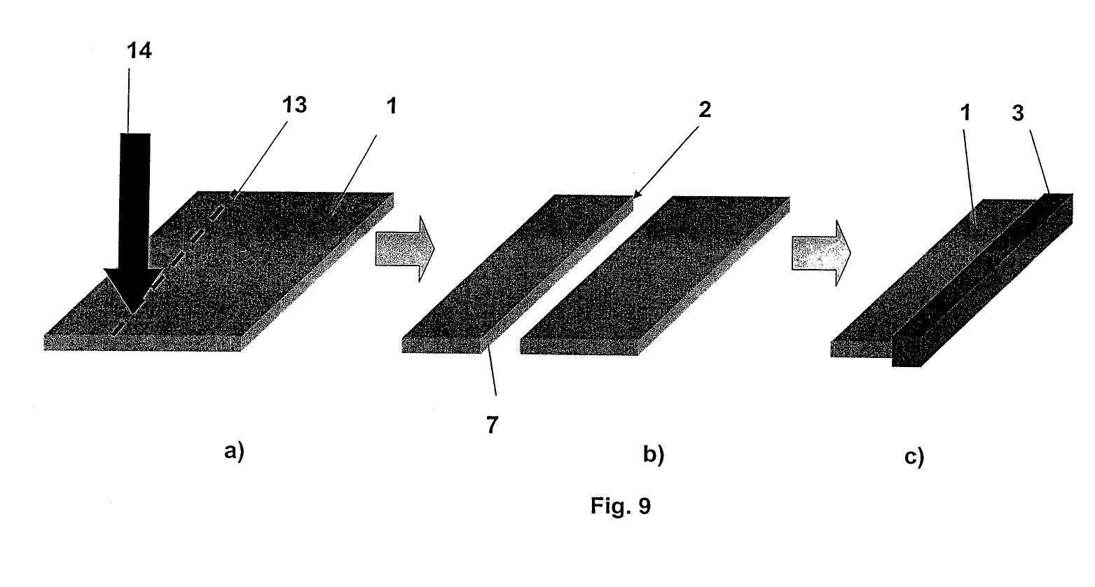

FIG. 9 shows a schematic process sequence for severing a glass plate 1 and for sheathing the produced glass edge.

Severing of the glass pane 1 comprising a thermal energy introduction is shown in FIG. 9a. For this purpose, a thermal energy source 14, preferably in the form of a high-energy laser beam, is guided along a desired severing line 13, by which the glass material is locally heated along the severing line 13.

Fundamentally, there are two main variants for the “thermal severing”. In the first variant, a crack in the glass material guided by thermal energy introduction, which extends through the thickness of the glass material, severs the glass pane along the intended contour. Two separate glass panes having thermally severed edges are thus directly obtained. A second variant comprises two steps, a thermal crack first being introduced into the glass surface and the glass pane then being conventionally broken. For this purpose, the area of the edge does not have to be contacted. It is sufficient if, for example, a glass pane is fixed and then lowered in a defined way and the thermal surface crack is thus broken off.

The second variant, that is, thermal scoring and then breaking, is more economically interesting, because this method variant is more easily integratable in principle in existing systems. After the glass pane 1 has been broken along the severing line 13 and a front face 2 has formed along the edge area 7 (see FIG. 9b), the front face 2 is immediately enclosed using a sheath 5, that is, without delay, even before the front face 2 may be subject to mechanical external influences (see FIG. 9c). The sheath may comprise a simple U-rail, preferably made of a plastic material, which may be applied to the glass edge to be protected in the course of an immersion, injection, spraying, foaming, push-on, or plug-on procedure.

### LIST OF REFERENCE NUMERALS

1 glass pane

2 front face

3, 4 glass pane faces

5 sheath

6 reinforcement elements, reinforcement materials

7, 8 edge areas

9 enclosed volume

10 joint

11 metal layer

12 support structure

13 severing line

14 thermal energy source

1-21. (canceled)

22. A method for producing a glass pane comprising:
severing the panel along at least one edge section by introducing thermal energy; and
immediately, after the production of the at least one edge section, enclosing the glass pane at least sectionally, along the at least one edge section with a sheath; and wherein
the sheath comprises plastic and is produced and applied around the at least one edge section by one of immersion, injection, spraying, foaming, a push-on procedure, or a plug-on procedure.

23. The method according to claim 22, wherein:
the glass pane is sheathed without physical contact with the at least one edge section and/or without mechanical tension and/or force acting on the at least one edge section.

24. A glass pane comprising:
at least one edge section produced by severing the panel with thermal energy introduction along the at least one edge; and
a sheath enclosing the at least one section which is applied at the time of production; and wherein
at least one edge section is applied by one of immersion, injection, spraying, foaming, a push-on procedure or a plug-on procedure.

25. The glass pane according to claim 24, comprising:
two diametrically opposite glass pane faces separated from one another by a thickness dimension of the glass pane; and wherein
the at least one edge section is defined by a front face which perpendicularly intersects both glass pane faces; and
the sheath completely encloses the front face and areas of the glass pane faces adjoining the front face.

26. The glass pane according to claim 24, wherein:
the sheath comprises plastic adhering to the glass panel.

27. The glass pane according to claim 25, wherein:
the sheath comprises plastic adhering to the glass panel.

28. The glass pane according to claim 26, wherein:
the plastic comprises at least one elastomer, organic elastomer, polyurethane, acrylic lacquer, acrylate, polyurethane, polyisocyanate, silicone, epoxide resin, PVC, polyethylene or polypropylene.

29. The glass pane according to claim 27, wherein:
the plastic comprises at least one elastomer, organic elastomer, polyurethane, acrylic lacquer, acrylate, polyurethane, polyisocyanate, silicone, epoxide resin, PVC, polyethylene or polypropylene.

30. The glass pane according to claim 24, wherein:
the sheath seamlessly adjoins the front face and areas of the glass pane faces seamlessly.

31. The glass pane according to claim 24, wherein:
the sheath is spaced apart from the front face and is only connected to the glass pane at the glass pane faces.

32. The glass pane according claim 24, wherein:
the sheath comprises material which is softer and more elastic than glass.

33. The glass pane according to claim 24, wherein:
the sheath is produced by one of immersion, injection, spraying, foaming, a push-on procedure, or a plug-on procedure.

34. The glass pane according to claim 24, wherein:
the sheath includes protective rails with a first material along the at least one edge section comprising a matrix which encloses the at least one edge section comprising a second material which provides a shape of the sheath with the second material being softer and less stable than the first material.

35. The glass pane according to claim 24, wherein:
the sheath is adhesively joined to the glass pane or is removably attached to an edge area.

36. The glass pane according to claim 24, wherein:
the sheath comprises at least one first material layer facing toward the glass pane which is enclosed by a second material layer which is harder than the first material layer and faces toward the glass pane.

37. The glass pane according to claim 36, wherein:
the harder second material comprises thermoplastic material or a metallic material.

38. The glass pane according to claim 24, wherein:
the sheath comprises at least two segments connectable to one another.

39. The glass pane according to claim 38, wherein:
the at least two segments of the sheath are connectable to one another along the front face of the glass pane.

40. The glass pane according to claim 24, wherein:
the sheath integrates the glass pane into a system receiving the glass pane.

41. The glass pane according to claim 40, wherein:
the sheath is implemented as a seal, damper, and/or a spring.

42. The glass pane according to claim 24, wherein:
the sheath comprises a material transparent to light or is a colored material.

43. The glass pane according to claim 24, wherein:
the sheath has a matte, glossy, or textured surface.
